(19) United States
(12) Patent Application Publication
(10) Pub. No.: US 2012/0033829 A1
(43) Pub. Date: Feb. 9, 2012

(54) Audio phase corrector

(76) Inventor: Ivan LaWayne Lewis, Monrovia, CA (US)

(21) Appl. No.: 12/806,026

(22) Filed: Aug. 4, 2010

(51) Int. Cl. H04R 1/40

(52) U.S. Cl. 381/97

(57) ABSTRACT

An audio phase corrector circuit which shifts the phase of substantially all frequencies of an audio signal by 90 degrees for the purpose of enhancing sound produced by an electroacoustic transducer. Embodiments are implemented by a digital finite impulse response filter configured to operate as a 90-degree phase shift circuit, commonly called a Hilbert transformer. The 90-degree phase shift corrects a characteristic phase distortion caused by electroacoustic transducers and thereby retains much of the impulse and transient information in the acoustic output that would otherwise be lost. The resulting sound has substantially improved clarity, detail, presence, placement, and spaciousness.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

The present invention generally relates to the field of electronic audio equipment. More particularly, the present invention relates to the field of audio signal conditioning circuits that enhance the quality of sound produced by electroacoustic transducers such as speakers, headphones, and hearing aids.

2. Background Prior Art

Audio signal conditioning circuits that enhance the quality of sound are hereafter referred to as audio enhancement circuits. Such circuits operate by altering an electrical signal that is an analog or digital representation of acoustic sound waves. The purpose of altering the signal is to cause an electroacoustic transducer to produce a sound that is perceived to be superior to the sound it would otherwise produce when driven by the unaltered signal.

In general, a prior art audio enhancement circuit alters an audio signal by selectively changing its amplitude or phase characteristics or by adding new frequencies to the signal. Usually these changes and additions are attempts to compensate for poor acoustic transient response by bolstering the amplitude and rise time of signal transients driving the transducer. Such attempts are justifiable because good acoustic transient response is necessary for producing the natural shape and frequency content of sound impulses, especially for percussive and vocal sounds. It appears that some implementations of the prior art have achieved modest to significant success if a comparison to their degree of commercial success is valid. But the prior art has significant shortcomings that have kept it from becoming more broadly applicable to the field of electroacoustic sound production. This is because, unlike the present invention, no implementation of the prior art consistently enhances sound without requiring adjustments for different operating conditions or without altering the program content of the original signal. Specific examples of prior art as related to the present invention are presented in the following paragraphs.

U.S. Pat. No. 4,482,866 to Crooks (1984) discloses a reference load amplifier correction system, which corrects for adverse characteristics such as inductive and capacitive reactance, inertia, and resonances of a power amplifier driven load such as a speaker or multiple speaker system. The Sonic Maximizer series of equipment produced by BBE Sound Inc. is based in part on U.S. Pat. No. ‘866’ and is one of the commercially successful implementations of an audio enhancement circuit. The various embodiments of U.S. Pat. No. ‘866’ alter the signal by changing the amplitude and phase of selected portions of the audio frequency spectrum. Adjustments are required for different operating conditions.

U.S. Pat. No. 5,424,488 to Werrbach (1995) discloses a transient discriminate harmonics generator that receives an audio input signal and produces an output signal containing harmonics of the input signal. The output signal is amplitude shaped as a function of the input signal's time and amplitude envelope. The Aural Exciter equipment produced by Aphex Systems Ltd. is based in part on U.S. Pat. No. ‘488’ and is another of the commercially successful implementations of an audio enhancement circuit. The various embodiments of U.S. Pat. No. ‘488’ alter the signal by adding harmonic frequencies associated with voltage transients in selected portions of the audio frequency spectrum. Adjustments are required for different operating conditions.

A class of widely used audio enhancement circuits consists of tube amplifiers, which add harmonics to the signal, especially when they are being mildly overdriven toward saturation. The resultant gentle rounding of transient signal peaks produces even harmonics that enhance the resulting sound in the minds of some listeners, including some that prefer and can afford high-end audiophile equipment. The appeal of tube amplifiers is based on a psychoacoustic effect produced by the added harmonics. But by adding harmonics, the tube amplifiers do indeed produce a form of distortion to the original signal.

There are a variety of audio related circuits in the prior art that do not enhance sound, but, for different purposes, they use a signal processing function that is also used in embodiments of the present invention. Said signal processing function implements an electronic filter that phase shifts substantially all frequencies in an audio signal by 90 degrees. Such a filter is commonly referred to as a Hilbert transformer. Two common uses of the Hilbert transformer that are representative of many similar uses in the prior art include encoding and decoding duplexed audio signals in surround sound systems and voice modulation and demodulation of single sideband carriers in radio communication systems. Other prior art uses involve esoteric analysis and manipulation of complex audio signals. A representative example of esoteric analysis and manipulation is U.S. Pat. No. 6,104,822 to Melanson and Lindemann (2000), which discloses a digital signal processing hearing aid having a plurality of digital signal processing means for processing input digital signals. In U.S. Pat. No. ‘822’ the Hilbert transformer is used in an audio bandsplitting process that has nothing to do with enhancing sound in the manner of the present invention. It is important to note that there are other circuits and software functions called Hilbert transformers that are used in the prior art, but they are not used to enhance sound in the manner of the present invention. Common examples of these are digital infinite impulse response (IIR) Hilbert transformers and analog allpass Hilbert transformers. Hilbert transformers such as these produce two signals in quadrature in which each frequency in one signal has a 90-degree phase difference with the same frequency in the other signal, but the relative phase of all the frequencies in the two signals are scrambled with respect to the original signal. The resulting phase scrambling is counterproductive to sound enhancement.

A theory of the art, as it relates to the prior art and the present invention, is presented in the following paragraphs. The theory describes a characteristic phase distortion produced by typical electroacoustic transducers and explains why the prior art fails to consider and correct the characteristic phase distortion. Also, it explains how the present invention corrects the characteristic phase distortion and presents a rationale for why the present invention thereby enhances sound. Since the efficacy of the present invention has been otherwise verified by listening tests, be advised that the validity of this theory is not a prerequisite to establishing the merits of the present invention.

3. Theory of the Art

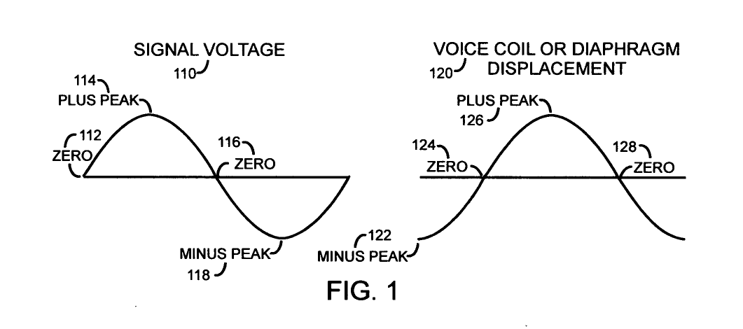

The prior art is mostly based on the premise that performance of an electroacoustic transducer, such as a speaker, can be enhanced by altering an audio signal to compensate for the transducer's distortion inducing inductance, capacitance, reverse electromotive force, inertia, friction, reflections, resonances, cone or diaphragm breakup, and vibration modes. But the prior art does not take into account that there is also a characteristic transfer function for an electrical-to-acoustic transducer that produces a −90-degree phase shift (Hilbert transform) distortion for all sinusoidal frequency components of the audio signal. In simple terms, if a hypothetical electrodynamic or electrostatic speaker produced no phase distortion other than that of its characteristic transfer function, in accordance with FIG. 1, a single cycle of continuous sinusoidal signal voltage 110 at its zero 112, plus peak 114, zero 116, and minus peak 118 voltages would produce a corresponding speaker's voice coil or diaphragm displacement 120 of minus peak 122, zero 124, plus peak 126, and zero 128. The dynamics of this source of phase distortion also applies to non-continuous signals such as impulses and transients. Of course the voice coil or diaphragm motion of real speakers deviate from the characteristic −90-degree phase shift, but this is primarily because of electrical current phase shift in the audio signal caused by the inductance of an electromagnetic voice coil or capacitance of an electrostatic diaphragm. Any other phase shift is primarily caused by speaker cone or diaphragm breakup, vibration modes, and resonances. Usually speaker cones are intentionally designed to have breakup and vibration modes in order to broaden their frequency response, but the unavoidable consequence is additional phase distortion. Other distortion factors of real speakers contribute primarily to harmonic and amplitude distortion, but they can also contribute to phase distortion. The present invention corrects the characteristic −90-degree phase shift distortion by applying a +90-degree phase shift, one time, anywhere in the audio signal chain prior to the speaker input. The need for the correction is based on a fact of physics that acceleration of a mass is proportional to the force exerted on it. This means that if a voice coil driven cone or a diaphragm motion is to correspond to an audio signal's original shape, zero signal voltages need to be transformed to peak voltages in order to produce the forces that cause the high-velocity zero crossing motion required of continuous signals and the fast leading edge motion of impulses and transients. Peak signal voltages need to be transformed to zero voltages to produce zero forces that stop motion. Signal voltages between the zeroes and peaks need to be transformed to values that produce proportional forces of the proper polarity for the motion required between the zeroes and peaks. The +90-degree phase shift correction to the transfer function produces the above described cone or diaphragm motion except for deviations caused by other sources of distortion. The resulting acoustic pressure waves should correspond to the original uncorrected signal voltage and the displacement of the cone or diaphragm.

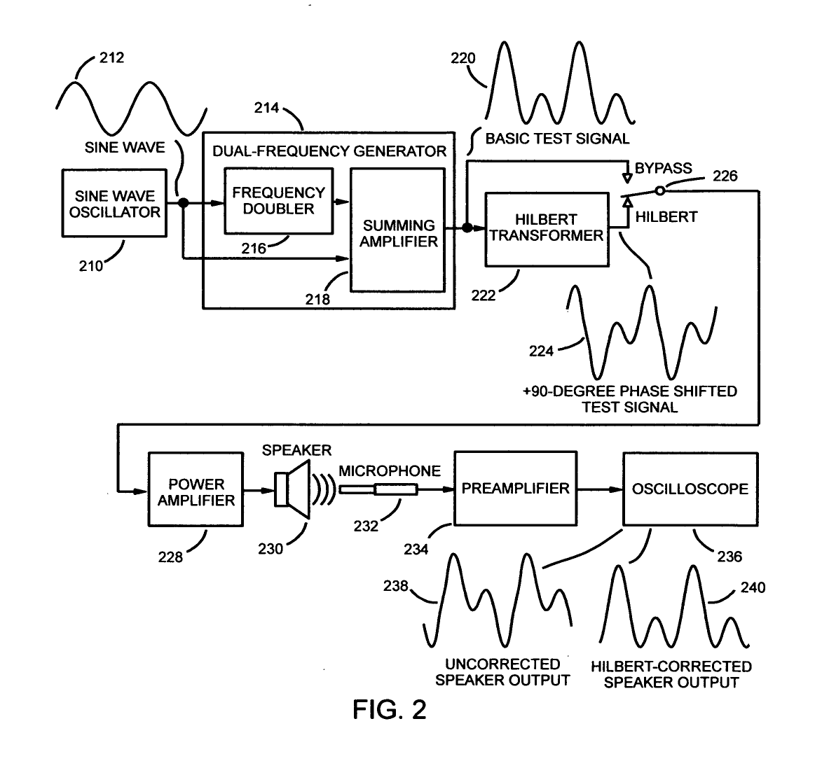

Verifying this theory with full bandwidth acoustic measurements is not easy to accomplish because of frequency group delay and the phase scrambling nature of real speakers and measurement microphones. However, the theory is bolstered by the results of a relatively simple phase shift measurement test of a speaker driven by an audio input signal consisting of two phase coherent frequencies. The phase shift measurement test setup is illustrated in FIG. 2. In the test setup, an adjustable sine wave oscillator 210 is set up to produce a continuous single-frequency sine wave 212 that drives a dual-frequency generator 214 consisting of a frequency doubler 216 and a summing amplifier 218. The outputs of the frequency doubler 216 and the sine wave oscillator 210 are summed by the summing amplifier 218 to produce a basic test signal 220. The basic test signal 220 is composed of two equal amplitude frequencies that are one octave apart and have a fixed phase relationship. The basic test signal 220 drives an inverting Hilbert transformer 222, which produces a +90-degree phase shifted test signal 224. The uncorrected characteristic transfer function of a speaker 230 is tested by setting a bypass/Hilbert switch 226 to its bypass position so that the basic test signal 220 drives a power amplifier 228 that in turn drives the speaker 230. The corrected characteristic transfer function of the speaker 230 is tested by setting the bypass/Hilbert switch 226 to its Hilbert position so that the +90-degree phase shifted test signal 224 drives the speaker 230 by way of the power amplifier 228. A measurement microphone 232 converts the acoustic output of the speaker 230 to an electrical signal, which is boosted by a preamplifier 234 and displayed on an oscilloscope 236. An uncorrected speaker output 238 and a Hilbert-corrected speaker output 240 are displayed on the oscilloscope 236 and should appear as shown in FIG. 2. Note that the Hilbert-corrected speaker output 240 appears the same as the basic test signal 220.

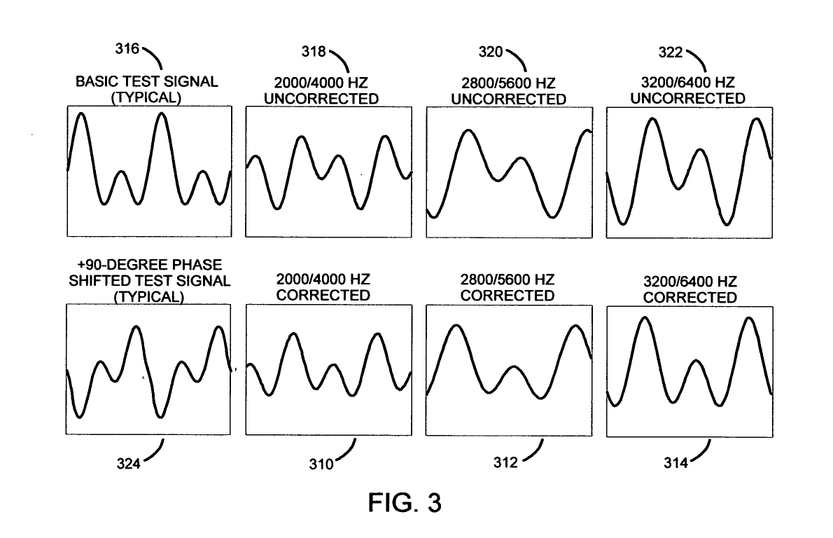

Using this test setup to measure phase response of a typical speaker's characteristic transfer function will usually produce a combination of supporting, conflicting, and ambiguous results at various output frequencies of the sine wave oscillator. This is because of the phase scrambling nature of most speakers. In order to mitigate such results, a test speaker was chosen for its low inductance and stiff cone to minimize phase shift other than that of the characteristic transfer function. Test frequencies were chosen to avoid resonances and vibration modes that would significantly distort amplitude and phase response. Even so, the test speaker had a relatively narrow band that was not significantly affected by other sources of distortion. Tracings of actual oscilloscope measurements of the test speaker transfer function and how they correlate to basic and +90-degree phase shifted test signals are presented in FIG. 3. Notice how the corrected measurements 310, 312, and 314 are similar to the basic test signal 316, and the uncorrected measurements 318, 320, and 322 are similar to an inverted form of the +90-degree phase shifted test signal 324.

An unavoidable question is, why does phase correction of an electroacoustic transducer's characteristic transfer function enhance sound in spite of all the other sources of phase distortion? The primary reason is that the characteristic phase distortion is the most pervasive and consistent form of phase distortion. By correcting frequency phase alignment for this form of distortion, much of the original signal's impulse and transient response is restored in the acoustic output of the transducer. This helps to restore the resolution and directivity information of the original signal. The general result is more clarity and detail in the sound. For stereophonic and multichannel systems there is a greater sense of presence, placement, directivity, and spaciousness. The ability of the present invention to enhance audio is limited only by any overriding influence of distortion from sources other than a transducer's characteristic transfer function.

### SUMMARY

The present invention enhances sound in a way that is simple in principle but technically sophisticated to implement and not intuitively obvious, which is probably why it was not previously anticipated. Unlike the prior art, it accomplishes its purpose without adding new frequencies to the original signal, without altering amplitude and phase characteristics of selected portions of the original signal, and without requiring adjustments for different operating conditions. Instead, the present invention shifts the phase of substantially all frequencies of an audio signal by 90 degrees for the sole and novel purpose of enhancing the sound produced by an electroacoustic transducer.

An embodiment of the present invention has been built and operated in combination with conventional audio signal sources, amplifiers, and electroacoustic transducers to produce sound that is significantly enhanced, especially for stereophonic and multichannel sound systems. Although phase shifting all frequencies by 90 degrees may seem an unlikely way to enhance sound, its efficacy has been thoroughly verified by the positive opinions of listeners. The sound improvement is initially subtle because there is virtually no change in program content. But as the brain quickly adapts to the 90-degree phase shift phenomenon, the listener notices a robust improvement in clarity, detail, presence, placement, directivity, and spaciousness. It is as if a veil has been removed and the sound has been transformed from two dimensions to three dimensions. Poorly produced program content is not transformed into good program content, but most program content is improved relative to its listenability. With respect to the prior art, it is possible that various implementations of it could be used in combination with the present invention to further compensate for perceived deficiencies in audio signals and equipment.

A broadly applicable and readily implemented form of the present invention is a finite impulse response (FIR) filter that operates in the digital domain. The FIR filter is configured to perform the function of the 90-degree phase shift circuit, which is commonly called a Hilbert transformer. The Hilbert transformer is a standard signal processing function that can be performed by a variety of hardware, software, and firmware implementations. The hardware basis can include but is not limited to a digital signal processor (DSP), field-programmable gate array (FPGA), or personal computer (PC) with sound card. With conventional input and output interface circuits the present invention can be integrated into any analog or digital context of an audio signal chain, from a program source to a power amplifier, either as an autonomous unit or imbedded within another unit of audio equipment.

### DRAWINGS

### Figures

FIG. 1 is an illustrative diagram showing the characteristic transfer function of a speaker by comparing the waveshape of a single cycle of sinusoidal input signal voltage to the resultant voice coil or diaphragm displacement.

FIG. 2 is a block diagram of a test setup used to measure frequency phase shift caused by the characteristic transfer function of a speaker.

FIG. 3 is an illustrative diagram that compares uncorrected and Hilbert-corrected speaker output waveshapes with basic and +90-degree phase shifted test signal waveshapes.

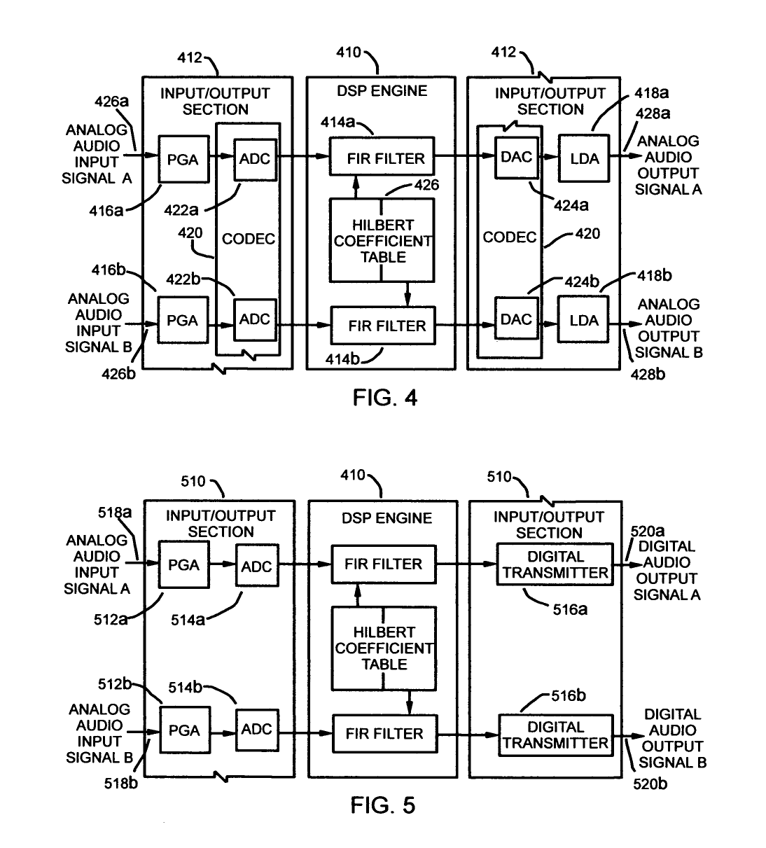

FIG. 4 is a block diagram of a DSP-based Hilbert transformer embodiment that enhances sound while operating in an analog-to-analog context of an audio signal chain.

FIG. 5 is a block diagram of a DSP-based Hilbert transformer embodiment that enhances sound while operating in an analog-to-digital context of an audio signal chain.

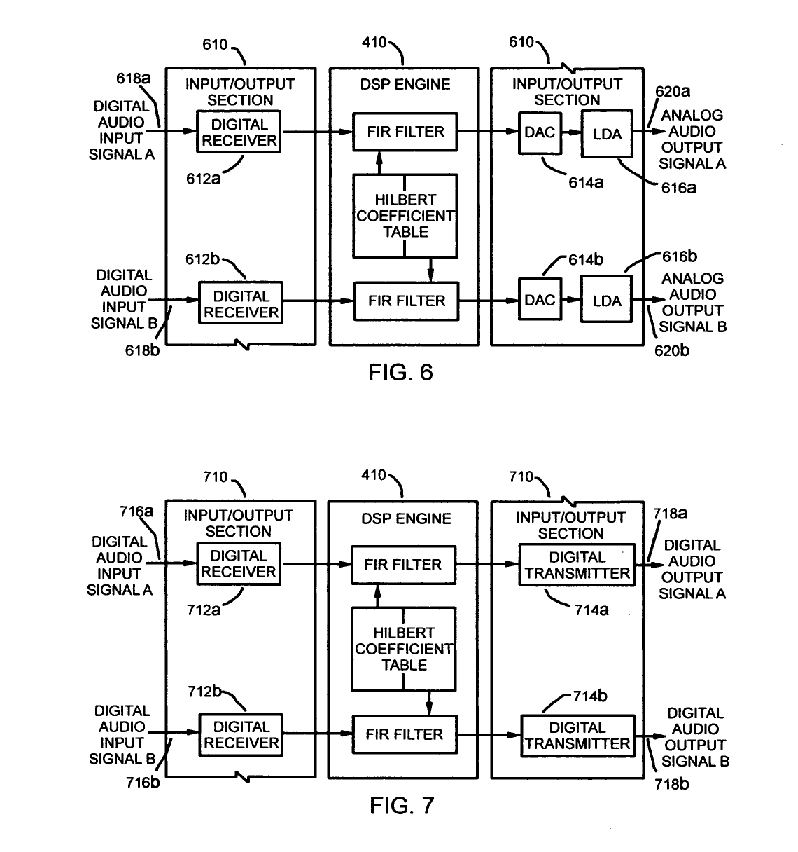

FIG. 6 is a block diagram of a DSP-based Hilbert transformer embodiment that enhances sound while operating in a digital-to-analog context of an audio signal chain.

FIG. 7 is a block diagram of a DSP-based Hilbert transformer embodiment that enhances sound while operating in a digital-to-digital context of an audio signal chain.

### DETAILED DESCRIPTION

One embodiment is a DSP-based Hilbert transformer used specifically to enhance sound produced by electroacoustic transducers while operating in an analog-to-analog context of an audio signal chain. With reference to FIG. 4, the embodiment is implemented with a stackable combination of a dspstak 21369zx DSP engine 410 and a dspstak c192k22 input/output section 412 manufactured by Danville Signal Processing, Inc. The embodiment described herein has two signal channels, but it can be implemented with any number of signal channels. It can also be implemented with other functionally similar custom made or commercially available hardware. This particular DSP engine 410 is based on an Analog Devices ADSP-21369 dual core, 24-bit SHARC DSP with a single-instruction, multiple-data (SIMD) computational architecture that allows the two channels of FIR filters 414a and 414b to operate on the same set of software instructions. The input/output section 412 consists of two input channels of programmable gain amplifiers (PGAs) 416a and 416b, two output channels of line driver amplifiers (LDAs) 418a and 418b, and an audio codec 420 that consists of two channels of analog-to-digital converters (ADCs) 422a and 422b and two channels of digital-to-analog converters (DACs) 424a and 424b. The PGAs 416a and 416b buffer and scale analog audio input signals 426a and 426b. The ADCs 422a and 422b convert the outputs of PGAs 416a and 416b to digital signals for processing in Hilbert configured FIR filters 414a and 414b of the DSP engine 410. The DACs 424a and 424b convert the digital signals out of the FIR filters 414a and 414b to analog signals. The LDAs 418a and 418b buffer and scale the outputs of the DACs 424a and 424b to produce analog audio output signals 428a and 428b.

A software program for the DSP engine 410 consists of a standard time-domain convolution FIR filter main routine and supporting software routines and drivers for the input and output interface. This particular software program is coded in a combination of Analog Devices Visual DSP++ assembly and C++ languages and provided by Danville Signal Processing, Inc. The embodiment can also be implemented with other functionally similar custom made or commercially available software applicable to the chosen DSP and its input/output hardware. A coefficient data table is used by the FIR filter main routine to invoke the Hilbert transformer function. In this form of the embodiment a data table of 3977 Hilbert coefficients (with three added zeros) for each channel is stored in DSP memory space for a Hilbert coefficient table 426 and used by the 3980-tap FIR filter main routine to achieve maximum frequency bandwidth with the DSP engine 410 operating at a 96,000 Hz sample rate and a 400 MHz instruction rate. Frequency response is flat from 20,000 Hz down to 40 Hz and is down by 2.5 dB at 20 Hz. The voltage gains of the PGAs 416a and 416b, the LDAs 418a and 418b, and the coefficients in the Hilbert coefficient table 426 should each be scaled to produce the desired net gain while preventing signal clipping.

Of the many resources for calculating Hilbert coefficient data tables, two commonly used ones are Iowegian's Scope FIR interactive filter design software, which can be downloaded from the interne, and PTC's Mathcad signal processing software. Also, Hilbert coefficients can be calculated in a manner describe by Lyons (See R. Lyons, Understanding Digital Signal Processing, Second Edition, Pearson Education, 2004, at 389-394). PC application software such as Scope FIR and Mathcad can generate or import Hilbert coefficients and graphically display their frequency and phase response for evaluation and amplitude scaling. An inverting Hilbert transformer that produces +90-degree phase shift is preferred in order to maintain correct audio signal polarity when there is no other polarity inversion in the audio signal chain. To accomplish this in this particular form of the embodiment, the Hilbert coefficient data should be arranged with negative coefficients preceding positive coefficients. However, if a −90-degree phase shift is implemented instead, or if the audio signal polarity otherwise gets inverted, the resulting sound out of an electroacoustic transducer will still sound essentially the same.

An alternative implementation of the Hilbert transformer function in software is a frequency-domain fast fourier transform (FFT) FIR filter main routine that can broaden the frequency bandwidth by adding approximately an octave or more of low frequency response for a given set of DSP hardware and software assets such as those described above.

Another embodiment is a DSP-based Hilbert transformer used specifically to enhance sound produced by electroacoustic transducers while operating in an analog-to-digital context of an audio signal chain. With reference to FIG. 5, the analog-to-digital form of the embodiment is implemented with the same or similar DSP engine 410 described above. An input/output section 510 consists of two channels of PGAs 512a and 512b, two channels of ADCs 514a and 514b, and two channels of digital transmitters 516a and 516b. The PGAs 512a and 512b (or their equivalents) buffer and scale analog audio input signals 518a and 518b. The ADCs 514a and 514b convert the outputs of the PGAs 512a and 512b to digital signals for processing in Hilbert configured FIR filters of the DSP engine 410. The digital transmitters 516a and 516b convert the digital signals out of the DSP engine 410 to one of several possible digital formats for digital audio output signals 520a and 520b, as required by the next stage of the audio signal chain. If a multiplexed digital audio output signal is required instead of the digital audio output signals 520a and 520b, a single digital transmitter such as a Sony/Philips Digital Interconnect Format (S/PDIF) transmitter is used instead of the digital transmitters 516a and 516b. A software program for the DSP engine 410 consists of the same or similar FIR filter main routine and supporting software routines described above and appropriate drivers for the input and output interface.

Another embodiment is a DSP-based Hilbert transformer used specifically to enhance sound produced by electroacoustic transducers while operating in a digital-to-analog context of an audio signal chain. With reference to FIG. 6, the digital-to-analog form of the embodiment is implemented with the same or similar DSP engine 410 described above. An input/output section 610 consists of two channels of digital receivers 612a and 612b, two channels of DACs 614a and 614b, and two channels of LDAs 616a and 616b. The digital receivers 612a and 612b convert digital audio input signals 618a and 618b from one of several possible digital formats to the digital format required by the DSP engine 410. If there is a multiplexed digital audio input signal instead of the digital audio input signals 618a and 618b, a single digital receiver such as an S/PDIF receiver is used instead of the digital receivers 612a and 612b. The DACs 614a and 614b convert the digital signals out of the DSP engine 410 to analog signals. The LDAs 616a and 616b buffer and scale the outputs of the DACs 614a and 614b to produce the analog audio output signals 620a and 620b. A software program for the DSP engine 410 consists of the same or similar FIR filter main routine and supporting software routines described above and appropriate drivers for the input and output interface.

Another embodiment is a DSP-based Hilbert transformer used specifically to enhance sound produced by electroacoustic transducers while operating in a digital-to-digital context of an audio signal chain. With reference to FIG. 7, the digital-to-digital form of the embodiment is implemented with the same or similar DSP engine 410 described above. An input/output section 710 consists of two channels of digital receivers 712a and 712b and two channels of digital transmitters 714a and 714b. The digital receivers 712a and 712b convert digital audio input signals 716a and 716b from one of several possible digital formats to the digital format required by the DSP engine 410. If there is a multiplexed digital audio input signal instead of the digital audio input signals 716a and 716b, a single digital receiver such as an S/PDIF receiver is used instead of the digital receivers 712a and 712b. The digital transmitters 714a and 714b convert the digital signals out of the DSP engine 410 to one of several possible digital formats for digital audio output signals 718a and 718b, as required by the next stage of the audio signal chain. If a multiplexed digital audio output signal is required instead of the digital audio output signals 718a and 718b, a single digital transmitter such as an S/PDIF transmitter is used instead of the digital transmitters 714a and 714b. A software program for the DSP engine 410 consists of the same or similar FIR filter main routine and supporting software routines described above and appropriate drivers for the input and output interface.

### CONCLUSION, RAMIFICATIONS, AND SCOPE

Accordingly the reader will see that at least one of the embodiments alters audio signals by shifting the phase of substantially all frequencies by 90 degrees for the purpose of enhancing the quality of sound produced by electroacoustic transducers, without otherwise altering the program content of the signals or requiring adjustments for different operating conditions.

While the above description contains many specifications, these should not be construed as limitations on the scope of any embodiment, but as exemplifications of the presently preferred embodiments thereof. Many other ramifications and variations are possible within the teachings of the various embodiments. For example, other hardware bases such as an FPGA or a PC with sound card can be used to implement an embodiment. Instead of operating in real time as described above, an embodiment can operate in delayed time or as a state machine using stored audio signal data. An embodiment can operate in a recording process or in a playback process, such as for audio disc or tape recordings. An audio signal produced by an embodiment can be stored on recording media such as audio discs or tapes or computer hard drives. Broadcast media such as radio and television can use an embodiment to process audio signals prior to transmission. Embodiments can be used to process audio signals in hearing aids. Embodiments can be used to process audio signals from microphones, electronic musical instruments, radios, televisions, computers, amplifiers, mixers, etc. Embodiments can be used to process audio in sound reinforcement systems.

Thus the scope of the invention should be determined by the appended claims and their legal equivalents, and not by the examples given.

1. A means for shifting the phase by 90 degrees of substantially all frequencies in an audio signal, whereby the resultant sound produced by an electroacoustic transducer is enhanced.

2. A finite impulse response filter means for shifting the phase by 90 degrees of substantially all frequencies in an audio signal, whereby the resultant sound produced by an electroacoustic transducer is enhanced.
